(19) United States
(12) Patent Application Publication
(10) Pub. No.: US 2005/0014896 A1
(43) Pub. Date: Jan. 20, 2005

(54) Cellulose fibre insulation and method of application

(76) Inventors: Alfredo Otto Schmidt, Kitchener (CA); Karl Molcar, Woodbridge (CA); David J. Krendl, Delphos, OH (US)

Correspondence Address: DARYL W SCHNURR;MILLER THOMSON LLP, PO BOX 578, SUITE 700, 22 FREDERICK STREET, KITCHENER, ON, N2G 4A2, CA

(21) Appl. No.: 10/892,109

(22) Filed: Jul. 16, 2004

Related U.S. Application Data
(60) Provisional application No. 60/487,602, filed on Jul. 17, 2003.

(51) Int. Cl. B05D 1/12; C08L 5/00

(52) U.S. Cl. 525/54.3; 427/180; 427/421.1; 252/62; 106/618; 106/619; 106/162.5; 106/162.51; 525/54.31

(57) ABSTRACT

A cellulose fibre insulation is a mixture of cellulose fibres and a fire retardant with a first additive. The first additive contains a plurality of adhesives and a surfactant. The mixture is sprayed simultaneously with a water spray onto a surface to be insulated to produce a cellulose fibre insulation with a low moisture content and low density. The plurality of adhesives is preferably starch, methylcellulose and ethylene vinyl acetate.

### BACKGROUND OF THE INVENTION

1. Field of the Invention

This invention relates to a cellulose fibre insulation having a low moisture content and a method of application of the insulation to sloped surfaces. More particularly, this invention relates to a cellulose fibre insulation containing one or more additives where the insulation can be sprayed onto sloped surfaces and will adhere thereto even though the insulation has a low moisture content.

2. Description of the Prior Art

It is known to combine cellulose fibre insulation with an aqueous solution of one or more adhesives and to spray the resulting mixture onto a wall. A major problem in the fibre insulation industry is that the resulting insulation has a moisture content of 25% or more. The high moisture content can damage the wood framing members or other material within the wall cavity or it may result in conditions that are conducive to the formation of mold. If the support members are damaged, the structural integrity of the building in which the insulation is used can be damaged. Excess moisture can also cause the wood to warp and/or shrink or twist resulting in customer complaints.

In some jurisdictions, government regulations prevent the use of fibre insulation where the sprayed on product has a moisture content exceeding a pre-determined level. For example, in Canada, building regulations require that sprayed on insulation must have a moisture content that does not exceed 20% based on the weight of the installed product. Some other jurisdictions do not have any moisture content restrictions but high moisture content spray on insulation creates problems. Numerous attempts have been made to produce a spray on cellulose fibre insulation that has a low moisture content, without success.

Some previous spray on insulation materials are much too expensive to be marketable. Cellulose fibres are relatively inexpensive, but additives to the fibres can make the product extremely expensive.

There are a number of U.S. patents naming Boyer et al as inventors describing various aspects of cellulose fibre insulation. These U.S. Pat. Nos. are 4,187,983, 4,360,440, 5,684,068, 5,853,802 and 6,251,476.

Previous cellulose fibre insulation and methods of installing such insulation suffer from one or more disadvantages in that the moisture content of the installed product is equal to or greater than 25% of the cellulose fibre by weight, or, the additive required to be mixed with the cellulose fibre is made on a wet basis off site, or, the insulation product is in liquid form at the manufacturing plant and is expensive and difficult to transport to the appropriate installation site, or, components are mixed at the manufacturing plant but begin to separate during transit, or, the final product is expensive and difficult to spray onto a surface, or, the product damages the support structure where the product is installed, or, conditions conducive to mold creation develop on the product with time, or, a barrier such as drywall, plastic film or mesh or netting is required to retain the product in position on a sloped surface, or, the product falls away from the structure where it is installed before it dries, or settles without drying, or the over-sprayed portion of the product is difficult to collect and expensive to dispose of, or, the product produces gases that are harmful to occupants, or, the cellulose fibre insulation when installed has a high density or, the fall away product cannot easily. be recycled.

### SUMMARY OF THE INVENTION

It is an object of the present invention to provide a cellulose fibre insulation that can be mixed in dry form with a first additive at a manufacturing plant, transported in dry form, for example, in bales to a job site, sprayed onto a sloped surface simultaneously with a water spray resulting in an installed product having a maximum moisture content of 24%. It is a further object of the present invention to have a final product with a moisture content of less than 22% and preferably not exceeding 20% based on the total weight of sprayed on insulation. It is still a further object of the present invention to provide a cellulose fibre insulation containing a first additive and a second additive where the mixture is dry and can be shipped to a job site in dry form. It is an object of the present invention to provide a cellulose fibre insulation where the insulation, after being installed with a water spray to produce a final product, has a low density and an improved R-factor compared to existing cellulose fibre insulation.

A fibrous cellulose insulation comprising a mixture of cellulose and a first additive, said first additive comprising a plurality of adhesives and a surfactant.

Preferably, the mixture contains a second additive containing borates.

Still more preferably, the mixture is dry and is in the form of a powder or a bale.

Preferably, the first additive is less than 5% of the cellulose fibres by weight and still more preferably is less than 2.5% of the cellulose fibres by weight. Still more preferably the first additive is less than 2% of the cellulose fibres by weight.

Preferably, moisture is added to the mixture during installation. Maximum moisture content is 24% and preferably less than 22% and still more preferably does not exceed 20%.

A fibrous cellulose insulation comprises a mixture of cellulose fibres, fire retardant and a first additive. The first additive enables the mixture to be applied to a sloped surface by spraying the mixture onto the surface with a water spray. The additive makes the insulation sticky and viscous enough to stick to the surface and to itself to allow a thick layer of insulation to be formed, yet slippery enough to allow for even flow when sprayed onto the surface with a water spray.

A fibrous cellulose insulation comprises a mixture of cellulose fibres and a first additive, the first additive comprising:
(a) substantially 50% by weight starch;
(b) substantially 25% by weight methylcellulose;
(c) substantially 20% by weight ethylene vinyl acetate; and
(d) substantially 5% by weight surfactant;
the first additive being less than 5% by weight of said cellulose fibre.

A fibrous cellulose insulation comprising a mixture of cellulose fibres, a plurality of adhesives, a surfactant and water, the insulation being sprayable and drying to a final solid product having a moisture content not exceeding 24% by weight of the final product.

A fibrous cellulose insulation comprising a mixture of cellulose fibre, a first additive and water, the first additive containing a plurality of adhesives, the water containing a surfactant, the insulation being sprayable and drying to a final product having a moisture content not exceeding 24%.

A fibrous cellulose insulation comprising a mixture of cellulose fibre, a plurality of adhesives and water, the water containing a surfactant and ethylene vinyl acetate, the insulation being sprayable and drying to a final product having a moisture content not exceeding 24%.

A fibrous cellulose insulation comprising a mixture of cellulose fibre and water, the water containing a first additive, the first additive being a plurality of adhesives and a surfactant, said insulation being sprayable and drying to final product having a moisture content not exceeding 24%.

A fibrous cellulose insulation comprising a mixture of cellulose fibre, a first additive and water, the first additive containing a plurality of adhesives and a surfactant, part of the first additive being contained in the water and part of the first additive being mixed with the cellulose fibre, the insulation being sprayable and drying to a final product having a moisture content not exceeding 24%.

Preferably, the moisture content does not exceed 20% and still more preferably does not exceed 18%.

A method of applying a fibrous cellulose insulation to a sloped surface to be insulated, said method comprising mixing cellulose fibres with a first additive containing a plurality of adhesives and a surfactant, adding water to said mixture by simultaneously blowing said insulation onto said surface with a water spray to produce a final solid product, after drawing, said product having a moisture content not exceeding 24% by weight of said final product.

A method of applying a fibrous cellulose insulation with a low moisture content to a surface to be insulated, said method comprising mixing a first portion of a first additive with cellulose fibres and a remaining portion of a first additive with water, said first additive containing a plurality of adhesives and a surfactant, adding said water containing said remaining portion of said first additive to said cellulose fibres containing said first portion of said first additive by spraying said water and said mixture to apply a final product to said surface, said final product having a maximum moisture content not exceeding 24% by weight of said final product after drawing.

A method of applying a fibrous cellulose insulation with a low moisture content to a surface to be insulated, said method 10 comprising mixing cellulose fibres with a first additive, the first additive containing a plurality of adhesives and a surfactant, introducing the mixture into a fibre dispensing machine having a first hose and a control system to spray the mixture in dry form, simultaneously adding water through a second hose connected to a water supply, said second hose having a liquid spray nozzle, simultaneously activating the fibre dispensing machine to spray the dry fibre onto said surface while simultaneously adding a minimum amount of water through said liquid spray nozzle, the water representing a maximum of 24% by weight of the insulation in a finished product, the finished product being thick enough and sticky enough to stick to said surface in a sufficiently thick layer to insulate the surface.

A method of applying a fibrous cellulose insulation with a low moisture content to a surface to be insulated, the method comprising mixing cellulose fibres with part of a first additive, the first additive containing a plurality of adhesives and a surfactant, introducing the mixture into a fibre dispensing machine having a first hose and a control system to spray the mixture in dryed form simultaneously adding water through a second hose connected to a water supply, the water containing part of the first additive, the second hose having a liquid spray nozzle simultaneously activating the fibre dispensing machine to spray the insulation onto the surface while simultaneously adding a minimum amount of water containing part of the first additive through the liquid spray nozzle, the water representing a maximum of 24% by weight of the insulation in a finished product, the finished product being thick enough and sticky enough to stick to the surface in a sufficiently thick layer to insulate the surface.

### BRIEF DESCRIPTION OF THE DRAWINGS

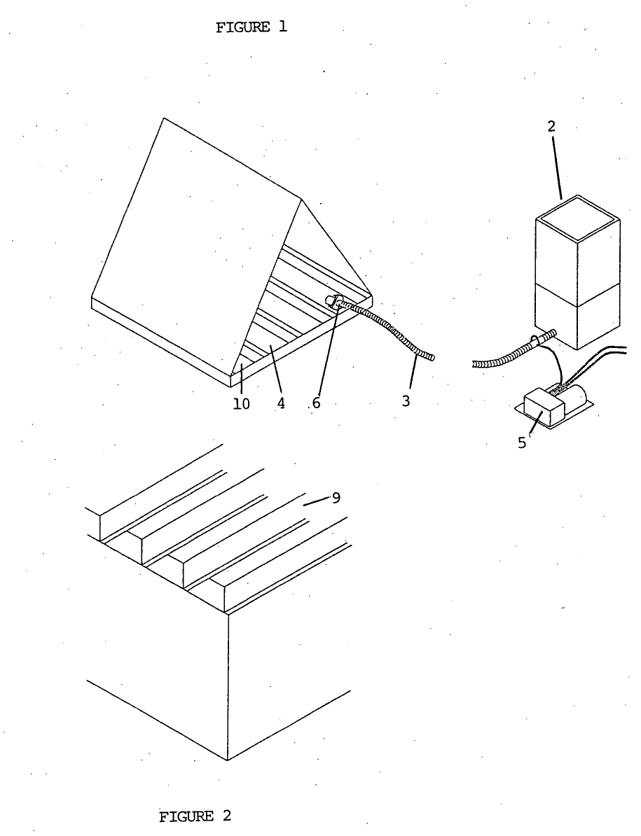

In FIG. 1, there is shown a perspective view of one embodiment of an installation system for an attic;

In FIG. 2, there is shown floor joists; and

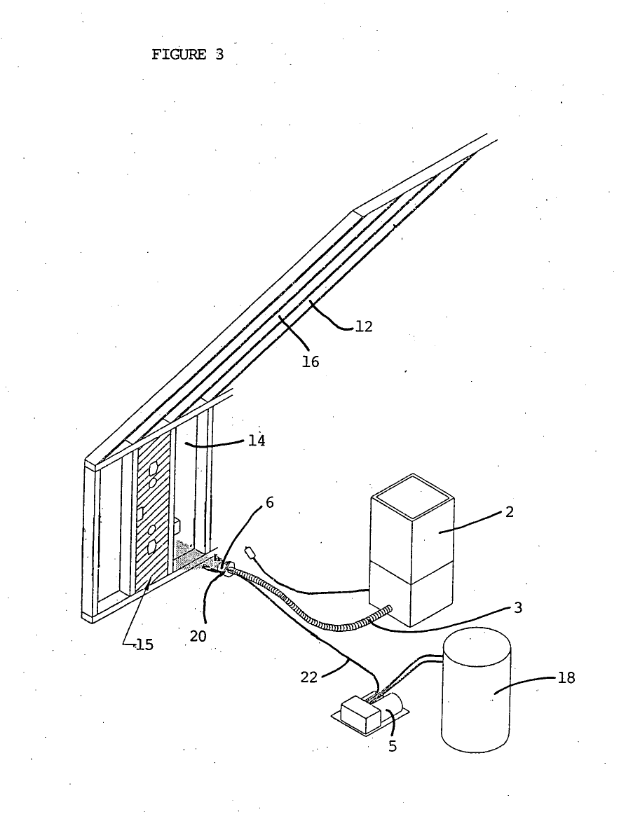

In FIG. 3, there is shown a perspective view of an installation system for a cathedral ceiling and a vertical wall.

### DESCRIPTION OF A PREFERRED EMBODIMENT

The term “sloped” or “sloped surfaces” and similar variations are defined to include “vertical” or “vertical surfaces” and a sloped surface is a non-horizontal surface. Cellulose fibres are mixed with a first additive containing a plurality of adhesives and a surfactant. Preferably, the adhesives are starch, methylcellulose and ethylene vinyl acetate (“EVA”). Preferably, the ethylene vinyl acetate is in dry form. By weight of the first additive, cellulose fibres, the starch is substantially 50%, the methylcellulose is substantially 25%, the ethylene vinyl acetate is substantially 20% and the surfactant is substantially 5%. The first additive represents less than 10% by weight of the cellulose fibres and preferably less than 5% by weight of the cellulose fibres. Still more preferably, the first additive represents from substantially 1.0% by weight to substantially 2.5% by weight of the cellulose fibres. Still more preferably, the first additive is substantially 2% by weight of the cellulose fibres.

Usually, a second additive is added to the cellulose fibres, the second additive containing borates. The second additive typically represents approximately 14% by weight of the cellulose fibres. Preferably, 45% or more of the second additive is borates. Still more preferably, substantially all of the second additive is borates. The borates include boric acid. The use of borates is conventional with cellulose insulation as the borates provide fire retardant and pesticide properties to the insulation. The borates are also a mould inhibitor. While the borates are referred to as a second additive, they can be added prior to or simultaneously with the first additive. Other fire retardants can be used along with or in place of the borates.

The starch is instant or cold water swellable cornstarch. Preferably, the starch is fast acting and of high quality. Other forms of starch can be obtained from rye, potatoes, wheat, sorghum, rice or tapioca. The starch acts as an adhesive and is a thickener.

The methylcellulose is preferably carboxymethylcellulose but hydroxypropylcellulose and hydroxyethylcellulose are also suitable. The methylcellulose reacts with the cellulose fibres only when wet and acts as an adhesive and as a thickener. Methylcellulose is a cellulosic ether. It is believed that other cellulosic ethers, including cellulose lower alkyl ethers, cellulose lower hydroxy alkyl ethers, cellulose lower alkyl lower hydroxy alkyl mixed ethers, combinations thereof, salts thereof and solution and reaction products of such combinations, solutions and salts can be used in place of all or some of the methylcellulose. Examples of cellulosic ethers include, but are not limited to, methylhydroxyethylcellulose, hydroxymethylethylcellulose, carboxymethylcellulose, ethylcellulose, hydroxyethylcellulose, hydroxyethylpropylcellulose and hydroxypropylcellulose.

The ethylene vinyl acetate (EVA) is preferably in dry form. Polyvinylacetate (“PVA”), preferably in dry form would also work, but ethylene vinyl acetate is preferred. Polyvinylalcohol (“PVOH”), if used in dry form, may work, but would not work as well as the EVA or the PVA. The PVA, EVA and PVOH are adhesives. The EVA is preferably ELOTEX FX2320 (a trademark) which is a redispersible binder based on a copolymer of vinyl acetate and ethylene. The Elotex FX2320 is EVA with an alcohol colloid coating. EVA is a water dispersible synthetic organic polymer and other such polymers are believed to work as well. EVA is insoluble in water.

The surfactant is a broad range of chemicals that is well known to those skilled in the art. The surfactant defines how the liquid reacts under movement or static motion and reduces the surface tension of the water. The surfactant ensures that when the water enters the fibres, it enters quickly to allow the chemicals in the first additive to be activated. Surfactant can be added to the water spray rather than being added to the dry powder. A preferred surfactant is DOWFAX DRY HYDROTROPE (a trade mark).

In a variation of the invention, instead of adding the first additive to the cellulose fibres in a dry mixture, all or part of the first additive can be added to the water. Then, when the water is added to the cellulose fibres or the cellulose fibre mixture when the insulation is being sprayed onto a surface to be insulated, the portion of the first additive that is contained in the water will be mixed with the cellulose fibres. If part of the first additive ingredients are added to the water, the surfactant or the EVA or both can be added to the water. The first additive or part of the first additive that is added to the water can be added in dry form or in the liquid state. While all or part of the first additive can be added to the water rather than added to the dry cellulose fibres, it is preferred to add the first additive to the dry cellulose fibres.

It is believed that the borates will also activate the EVA or PVA or PVOH, as well as the methylcellulose, propylcellulose or ethylcellulose.

While the second additive contain borates (borax and boric acid), it is preferably substantially 14% of the cellulose fibres but could range from 13 to 17%, more or less of the cellulose fibres. For example, if the second additive is 14% of the cellulose fibres, 7% can be borax and 7% can be ammonium sulfate. Aluminum sulfate can be used in place of ammonium sulfate. The second additive is conventional.

When the fibrous cellulose insulation is used on a horizontal or substantially horizontal surface such as the joists in an attic, the fibrous cellulose insulation can be blown in the space between the joists in dry form as long as settling is allowed for (approximately 12%). Similarly, when used in wall cavities of existing construction, a dry form of the insulation can be blown into the cavity as the existing drywall or plaster will retain the insulation within the cavity. As shown in FIGS. 1 and 2, a fibre dispensing machine 2 receives the fibre (not shown) in bale or powder form. A fibre dispensing machine receives the fibre in bale or powder form. A pump 5 is connected to blow air through a hose extending between the fibre dispensing machine and the location where the insulation is to be blown 4. The air travelling through the hose carries the mixture of cellulose fibres and first additive (or first and second additive) through the hose to the attic. The hose has a dry fibre spray nozzle 6 at a free end thereof. As stated, there is no need to add moisture as it is not necessary for the mixture to be sticky or to stick to floor joists 9 or ceiling 10 as the dry fibres will rest in place by gravity, the ceiling being horizontal.

However, it may be desirable to spray attics and other horizontal areas with the cellulose insulation and water. Additional amounts of insulation do not have to be applied to allow for settling as the amount of settling is minimal (less than 5%) when moisture is added. The fibre dispensing machine is conventional and has a hopper, agitators and basic controls for air supply and fibre feed rate (not shown). The fibre dispensing machine introduces fibrous cellulose insulation under pressure through the hose to the spray nozzle at a free end of the hose. The apparatus shown in FIG. 1 has optional internal nozzles connected to a water pump 5, but water need not be added when the insulation is blown into an attic. Cellulose fibre insulation that is sprayed into an attic with water is often referred to as stabilized cellulose.

In FIG. 3, when the fibrous cellulose insulation (not shown) is desired to be sprayed onto the underside of a cathedral ceiling or sloped ceiling 12 or into a vertical or other sloped wall cavity 14, moisture must be added in order to make the fibrous cellulose insulation stick to the underside of the ceiling or to the wall cavity. In some new construction, it may be desirable to use a wall jig or barrier film 15 such as plastic netting, plastic webbing or plastic sheeting (not shown) to assist in holding the insulation in place. The barrier film preferably will have openings therein into which the spray nozzle can be introduced. Preferably, the fibrous cellulose insulation with moisture added will be sprayed directly into a vertical or sloped wall or ceiling cavity without the use of netting or other means to assist in holding the insulation in place. The same reference numerals are used in FIG. 3 to describe those components that are identical to the components shown in FIG. 1.

In FIG. 3, it can be seen that in addition to the fibre dispensing machine 2, which blows the dry fibrous cellulose insulation (not shown) through a hose 3 and dry fibre spray nozzle 8 into a wall cavity 14 or ceiling cavity 16. The application system has, in addition, a liquid tank 18, which preferably contains water (not shown). The pump 5 pumps liquid from the liquid tank to liquid spray nozzles 20 on either side of the dry fibre spray nozzle 6 on the hose 3 from the fibre dispensing machine 2 simultaneously with the dry insulation. The liquid is preferably water. In other words, there is a water supply hose 22 connected to two nozzles located on either side of the dry fibre spray nozzle on the hose from the fibre dispensing machine. A medium pressure water tap line (not shown) can be substituted for either the pump or liquid storage tank, providing a reservoir for the pump. The water line could feed the pump directly to step up the water pressure and eliminate the need for a storage tank. If the water supply from tap water has the required pressure, it can be fed directly into the liquid spray nozzles on either side of the dry fibre spray nozzle without the necessity of a pump or liquid storage tank.

The dry fibre spray nozzle consists of a larger input for the dry fibrous cellulose insulation from the fibre dispensing machine. The moisture is added by the liquid spray nozzles mounted outside the dry fibre spray nozzle. The liquid spray nozzles activate the chemicals in the first and second additives to make the fibrous cellulose insulation sticky and viscous enough to form a layer thick enough to comprise insulation.

Alternatively, the hose from the fibre dispensing machine can have an internal spray nozzle (see FIG. 1) whereby an aqueous solution under pressure is applied into an interior of the mixing chamber. The mixing chamber or tube is used to coat the fibres internally at multiple injection points along the nozzle. This internal mixing/coating chamber can be inserted into any location along the hose length from the machine to the exit point of the hose. The function of this nozzle is to pre-wet and activate the fibrous mixture applied in a closed cavity or attic, but also in a vertical wall or ceiling.

The dry fibre spray nozzle preferably has a diameter of 2 to 3 inches and the mixing chamber or tube for the internal spray nozzle preferably has a diameter of 2 to 4 inches.

For walls and cathedral ceilings, it will be necessary to remove excess sprayed fibre from the wall support or ceiling support (wall studs or rafters) and oversprayed fibre. Preferably, the moisture added to the dry fibrous cellulose insulation containing cellulose fibre and a first additive (or cellulose fibre and a first and second additive) will not exceed 20% by weight of the fibrous cellulose fibre insulation after installation. Preferably, the mixture is applied at less than 2 pounds per cubic foot density. There is preferably less than 5% settling after the installed insulation has dried.

Preferably, fibrous cellulose insulation containing one or both additives is combined and packaged in a dry bale form. The material is activated by adding a minimal amount of water or other liquid to cause the material to adhere to many surfaces as well as to adhere to itself. The sticky viscous material resulting from the addition of a minimal amount of moisture will stick to almost any surface. The low density of the product increases the coverage while also improving the insulation characteristics (i.e. R-Value). The material can be applied underneath horizontal surfaces as well.

The amount of the first additive preferably ranges from substantially 1.0% to substantially 10% by weight of the cellulose fibre and more preferably ranges from ½% to 5% still more preferably ranges from substantially 1.5% to substantially 2% by weight of the cellulose fibre. Still more preferably, the first additive is substantially 2% by weight of the cellulose fibre. Preferably, the borates in the second additive range from substantially 10% to substantially 14% of the cellulose fibre by weight. In some product tests, the moisture content of the final product has been found to be 19% and even less than 18% by weight of the fibrous cellulose insulation. In other product tests, the moisture content of the final product has been found to be 15% (average) by weight of the fibre cellulose insulation or less. In other tests, the final product can be found to have a moisture content of 10% by weight. Recycle is preferably less than substantially 30% by volume of total insulation. Before spraying the insulation, the wall is preferably pre-wetted by spraying water onto the wall. Further, the density of the cellulose fibre insulation prepared in accordance with the present invention ranges from substantially 1.0 lbs/ft³ to substantially 2.0 lbs/ft³.

In tests of the first additive that have been conducted, the first additive had the following ingredients in the following ratios: starch, 20 pounds; methylcellulose, 10 pounds; EVA, 8 pounds; and surfactant, 2.77 pounds. In other tests of the first additive, the first additive had the following ingredients in the following ratios: starch, 16.0 pounds; methylcellulose 7.5 pounds; EVA, 5.0 pounds; and surfactant, 1.5 pounds. In still other tests that have been conducted, the first additive had the following ingredients and the following ratios: starch, 15 pounds; methylcellulose, 7.5 pounds; EVA, 6.0 pounds; and surfactant, 1.5 pounds.

When the cellulose fibre insulation is sprayed onto a sloped surface such as a vertical wall or a cathedral ceiling, the insulation must be viscous enough and sticky enough to be applied in a thick layer that will adhere to the wall without excessive fall-off, and not fall away while it dries. The insulation must also be moist enough to stick together but free flowing enough to be sprayable onto the wall with a small amount of moisture. The insulation must also dry properly to a solid final product, preferably with a hard surface so that it will not be so easily damaged. The drying period, during which the moisture is allowed to evaporate, will vary with conditions but usually takes about one hour.

Insulation of the present invention has an improved R-value over conventional cellulose fibre insulation. Also, air infiltration and sound-muffling qualities are improved because of the density of the final product which ranges from substantially 1.2 lbs/ft³ to substantially 2.0 lbs/ft³. A source of cellulose fibre is used or waste newsprint. The final product preferably dries with a hard surface.

While the invention has been described in some detail, the most important features of the invention are the low moisture content and the low density of the final product after the product is sprayed by adding water, into a sloped surface which can be a wall cavity or cathedral ceiling cavity. While part of the first additive can be added to the water before spraying and the remaining part of the first additive can be added to the dry mixture, it is preferred to add the entire first additive to the dry mixture so that only water is sprayed. While methylcellulose, starch and ethylene vinyl acetate are the preferred ingredients for the adhesives, it is believed that other adhesives can be made to work along with or in substitution for the three preferred adhesives. For example, it is believed that other adhesives such as various gums, dextrans and sodium silicates can be used as substitutes for some or all of the adhesives. Gums are polysaccharide materials and include but are not limited to agar, ghar gum, acacia gum, carrageenan gum and gatti gum. Cellulose-based polysaccharides include methylated hydroxyl celluloses and these may also work as may cellulosic esters.

Those skilled in the art will choose the ingredients that are inexpensive and non-toxic, but can be mixed with cellulose fibres to produce fibrous cellulose insulation that can be installed by spraying onto a location with a water spray simultaneously operated while the insulation is being blown to produce a final product that is sticky enough to be sprayed onto sloped surfaces in a thick layer, thick enough to remain in position while it dries, yet slippery enough to be applied smoothly and evenly to the location. The final product has a low density, relatively high R-factor compared to previous fibrous cellulose insulation and a low moisture content. The preferred ingredients produce a final product that has these properties. The preferred ingredients for the first additive are starch, methylcellulose, ethylene vinyl acetate and surfactant. The low density results in less insulation being required per cubic foot of finished product. The scope of the invention is indicated by the appended claims and all changes or variations that come within the meaning and range of equivalency of the claims are to be embraced within their scope.

1. A fibrous cellulose insulation comprising a mixture of cellulose and a first additive, said first additive comprising a plurality of adhesives and a surfactant.

2. A fibrous cellulose insulation as claimed in claim 1 wherein the first additive is less than 10% by weight of said cellulose fibre.

3. A fibrous cellulose insulation as claimed in claim 1 wherein said first additive ranges from substantially 1% by weight to substantially 10% by weight of said cellulose fibre.

4. A fibrous cellulose insulation as claimed in claim 1 wherein said first additive ranges from substantially 1.0% by weight to substantially 2.5% by weight of said cellulose fibre.

5. A fibrous cellulose insulation as claimed in claim 1 wherein said first additive is substantially 1.5% to substantially 2% by weight of said cellulose fibre.

6. A fibrous cellulose insulation as claimed in claim 1 wherein said first additive is less than substantially 2% by weight of said cellulose fibre.

7. A fibrous cellulose insulation as claimed in any one of claims 1, 3 or 5 wherein a density of the insulation ranges from substantially 1.2 lbs/ft³ to substantially 2.0 lbs/ft³ after water has been added to produce a final solid product.

8. A fibrous cellulose insulation as claimed in any one of claims 1, 3 or 5 wherein said insulation contains water resulting in a final solid product having a moisture content not exceeding 24% by weight of said final solid product.

9. A fibrous cellulose insulation as claimed in any one of claims 1, 3 or 5 wherein said insultation contains water and is a final product with a moisture content of less than 20% by weight.

10. A fibrous cellulose insulation as claimed in any one of claims 1, 3 or 5 wherein said insulation is in powder form.

11. A fibrous cellulose insulation comprising a mixture of cellulose fibre and a first additive containing a plurality of adhesives and a surfactant, said insulation being sprayable onto a sloped surface when a small amount of water is added, said insulation sticking to said surface and to itself so that a thick layer of several inches thick can be formed with little fall-off, said insulation drying to a final solid product having a moisture content not exceeding 24% by weight of said final product.

12. A fibrous cellulose insulation as claimed in claim 11 wherein the insulation contains a fire retardant.

13. A fibrous cellulose insulation as claimed in claim 11 wherein the fire retardant contains at least one select from the group of borates, boric acid, borax, ammonium sulphate and aluminum sulphate.

14. A fibrous cellulose insulation as claimed in claim 1 wherein the plurality of adhesives includes a water dispersible synthetic organic polymer.

15. A fibrous cellulose insulation as claimed in claim 1 wherein the plurality of adhesives are a water swellable starch, a cellulosic ether and a water dispersible synthetic organic polymer.

16. A fibrous cellulose insulation as claimed in claim 14 wherein the plurality of adhesives includes starch and a cellulosic ether.

17. A fibrous cellulose insulation as claimed in claim 15 wherein the cellulosic ether is methylcellulose.

18. A fibrous cellulose insulation as claimed in claim 15 wherein the water dispersible synthetic organic polymer is ethylene vinyl acetate.

19. A fibrous cellulose insulation as claimed in claim 17 wherein the methylcellulose is selected from the group of carboxymethylcellulose, hydroxypropylcellulose and hydroxyethylcellulose.

20. A fibrous cellulose insulation as claimed in claim 1 wherein the plurality of adhesives are water swellable starch, methylcellulose and ethylene vinyl acetate.

21. A fibrous cellulose insulation as claimed in claim 20 wherein the first additive comprises substantially 50% by weight water swellable starch, substantially 25% by weight methylcellulose, substantially 20% by weight ethylene vinyl acetate and substantially 5% by weight surfactant, said first additive being less than 5% by weight of said cellulose fibre.

22. A fibrous cellulose insulation as claimed in claim 1 wherein the plurality of adhesives are selected from the group of a water swellable starch, a cellulosic ether, a cellulosic esther, a water dispersible synthetic organic polymer, sodium silicates, dextrans, polysaccharide materials and gums.

23. A fibrous cellulose insulation comprising a mixture of cellulose fibre, a first additive and water, said first additive containing a plurality of adhesives, said water containing a surfactant, said water being sprayable and drying to a final product having a moisture content not exceeding 24% by weight of said product.

24. A fibrous cellulose insulation comprising a mixture of cellulose fibre, a plurality of adhesives, and water, said water containing a surfactant and ethylene vinyl acetate, said insulation being sprayable and drying to a final product having a moisture content not exceeding 24% by weight of said product.

25. A fibrous cellulose insulation comprising a mixture of cellulose fibre, a first additive and water, said first additive containing a plurality of adhesives and a surfactant, said first additive being contained in said water, said insulation being sprayable and drying to a final product with a moisture content not exceeding 24% by weight of said product.

26. A fibrous cellulose insulation as claimed in any one of claims 11, 13 or 23 wherein the moisture content of the final product does not exceed 20% by weight of said final product.

27. A fibrous cellulose insulation as claimed in claim 24 wherein said moisture content does not exceed 20% by weight of said final product.

28. A fibrous cellulose insulation as claimed in any one of claims 11, 13 or 23 wherein said insulation contains a second additive, said second additive containing borates.

29. A fibrous cellulose insulation as claimed in claim 24 wherein said insulation contains a fire retardant.

30. A fibrous cellulose insulation comprising a mixture of cellulose fibre, a plurality of adhesives, a surfactant, borates and water, said insulation being sprayable and drying to a final product, said product having a moisture content not exceeding 24% by weight of the said final product.

31. A fibrous cellulose insulation as claimed in any one of claims 23 or 25 wherein said moisture content does not exceed 20% by weight of said final product.

32. A fibrous cellulose insulation comprising a mixture of cellulose fibre, a fire retardant, a first additive and water, said first additive containing a plurality of adhesives, said water containing a surfactant, said insulation being sprayable and drying to a final product having a moisture content not exceeding 24%.

33. A fibrous cellulose insulation comprising a mixture of cellulose fibre, a fire retardant, a first additive and water, said water containing a surfactant and ethylene vinyl acetate.

34. A fibrous cellulose insulation comprising a mixture of cellulose fibre, a fire retardant, a first additive and water, said water containing a first additive said being sprayable and drying to a final product having a moisture content not exceeding 24%.

35. A fibrous cellulose insulation comprising a mixture of cellulose fibres, fire retardant and a first additive, said first additive enabling the mixture to be applied to a sloped surface by spraying said mixture onto said surface along with a water spray, said additive and water making the insulation sticky and viscous enough to stick to said surface and to itself with little fall off to allow a thick layer of insulation to be formed, and slippery enough to allow for even spraying with water to produce a final product of a moisture content not exceeding 24% by weight.

36. A fibrous cellulose insulation as claimed in claim 35 wherein said first additive has a plurality of adhesives and a surfactant.

37. A fibrous cellulose insulation as claimed in claim 36 wherein said plurality of adhesives is a water swellable starch, methylcellulose and ethylene vinyl acetate.

38. A fibrous cellulose insulation as claimed in claim 36 wherein said final product has a moisture content not exceeding 20% by weight after ying.

39. A fibrous cellulose insulation as claimed in claim 38 wherein said final product has a density ranging from substantially 1.2 pounds per cubic foot to substantially 2.0 pounds per cubic foot.

40. A fibrous cellulose insulation as claimed in any one of claims 1, 3 or 4 wherein one of the adhesives is ethylene vinyl acetate.

41. A method of applying a fibrous cellulose insulation to a sloped surface to be insulated, said method comprising mixing cellulose fibres with a first additive containing a plurality of adhesives and a surfactant, said mixture being in powder form, adding water to said mixture by simultaneously blowing said insulation onto said surface with a water spray to produce a final solid product, after drying, said final product having a moisture content not exceeding 24% by weight.

42. A method of applying a fibrous cellulose insulation to a surface to be insulated, said method comprising mixing a first additive containing a plurality of adhesives with cellulose fibres and water containing a surfactant by spraying said water and said fibres onto said surface simultaneously.

43. A method of applying a fibrous cellulose insulation with a low moisture content to a sloped surface, said method comprising mixing cellulose fibres with a first additive containing a plurality of adhesives and a surfactant, adding water to produce a final product, spraying said final product on said sloped surface, said water representing a maximum of 24% by weight of said final product after drying.

44. A method as claimed in claim 41 wherein said water represents a maximum of 20% by weight of said final product.

45. A method of applying a fibrous cellulose insulation and a low moisture content to a surface to be insulated, said method comprising mixing a first portion of a first additive with cellulose fibres and a remaining portion of a first additive with water, said first additive containing a plurality of adhesives and a surfactant, adding said water containing said remaining portion of said first additive to said cellulose fibres containing said first portion of said first additive by spraying said water with said mixture to apply a final product to said surface, said final product having a maximum moisture content not exceeding 24% by weight of said final product.

46. A method of applying a fibrous cellulose insulation with a low moisture content to a sloped surface, said method comprising mixing cellulose fibres with a first additive containing a plurality of adhesives and a surfactant, adding water to produce a final product, said water representing a maximum of 18% by weight of said final product and spraying said final product on said sloped surface.

47. A method of applying a fibrous cellulose insulation with a low moisture content to a surface to be insulated, said method comprising mixing cellulose fibres with a first additive, the first additive containing a plurality of adhesives and a surfactant, introducing the mixture into a fibre dispensing machine having a first hose and a control system to spray the mixture in dry form, simultaneously adding water through a second hose connected to a water supply, said second hose having a liquid spray nozzle, simultaneously activating the fibre dispensing machine to spray the dry fibre onto said surface while simultaneously adding a minimum amount of water through said liquid spray nozzle, the water representing a maximum of 24% by weight of the insulation in a finished product, the finished product being thick enough and sticky enough to stick to said surface in a sufficiently thick layer to insulate the surface.

48. A method of applying a fibrous cellulose insulation with a low moisture content to a surface to be insulated, the method comprising mixing cellulose fibres with part of a first additive, the first additive containing a plurality of adhesives and a surfactant, introducing the mixture into a fibre dispensing machine having a first hose and a control system to spray the mixture in dryed form simultaneously adding water through a second hose connected to a water supply, the water containing part of the first additive, the second hose having a liquid spray nozzle simultaneously activating the fibre dispensing machine to spray the insulation onto the surface while simultaneously adding a minimum amount of water containing part of the first additive through the liquid spray nozzle, the water representing a maximum of 24% by weight of the insulation in a finished product, the finished product being thick enough and sticky enough to stick to the surface in a sufficiently thick layer to insulate the surface.

49. A method as claimed in any one of claims 41, 43 or 47 wherein said adhesives are a water swellable starch, a cellulosic ether and a water dispersible synthetic organic polymer.
